(19) United States
(12) Patent Application Publication
(10) Pub. No.: US 2026/0311987 A1
(43) Pub. Date: Oct. 8, 2026

(54) Beam Homogenization for Trapped Ion Processing with Discrete Ion Packets

(71) Applicant: DH Technologies Development Pte. Ltd., Singapore (SG)

(72) Inventors: Pavel RYUMIN, North York (CA); Wen JIN, Concord (CA); Igor CHERNUSHEVICH, Toronto (CA); Takashi BABA, Richmond Hill (CA)

(73) Assignee: DH Technologies Development Pte. Ltd., Singapore (SG)

(21) Appl. No.: 19/478,885

(22) PCT Filed: Apr. 26, 2024
(86) PCT No.: PCT/IB2024/054082

§ 371 Date: Oct. 27, 2025

Related U.S. Application Data
(60) Provisional application No. 63/462,652, filed on Apr. 28, 2023.

(51) Int. Cl. H01J 49/06; H01J 49/40; H01J 49/42

(52) U.S. Cl. CPC H01J 49/062; H01J 49/40; H01J 49/4205

(57) ABSTRACT

In one aspect, a mass spectrometer is disclosed, which includes an ion trapping device, at least one pressurized ion guide configured to allow establishment of an adjustable axial field therein such that the axial field can be adjusted to operate the pressurized ion guide in any of a fast and a slow operational setting, a mass analyzer for receiving ions passing through the pressurized ion guide and configured to provide mass analysis of the received ions, and a controller in communication with said at least one pressurized ion guide for causing the adjustment of the axial field so as to switch the operational setting of the pressurized ion guide between the fast and the slow operational settings based on an operational mode of the mass spectrometer.

### RELATED APPLICATIONS

This application claims priority to U.S. Provisional Application No. 63/462,652 filed on Apr. 28, 2023, the contents of which are incorporated herein in their entirety.

### TECHNICAL FIELD

The present disclosure relates to mass spectrometry and more particularly to methods and systems for enhancing dynamic range of signal acquisition in mass spectrometry.

### BACKGROUND

The present teachings are generally directed to systems and methods for mass spectrometry, and more particularly, to such systems and methods for enhancing dynamic range in mass spectrometric analyses in which dissociation of precursor ions (e.g., via electron activated dissociation) is employed to generate fragment ions.

Mass spectrometry (MS) is an analytical technique for determining the structure of test chemical substances with both qualitative and quantitative applications. MS can be useful for identifying unknown compounds, determining the composition of atomic elements in a molecule, determining the structure of a compound by observing its fragmentation, and quantifying the amount of a particular chemical compound in a mixed sample. Mass spectrometers detect chemical entities as ions such that a conversion of the analytes to charged ions must occur.

### SUMMARY

In one aspect, a mass spectrometer is disclosed, which includes an ion trapping device, at least one pressurized ion guide configured to allow establishment of an adjustable axial field, e.g., a DC axial field, therein such that the axial field can be adjusted to operate the pressurized ion guide in any of a fast and a slow operational setting, a mass analyzer for receiving ions passing through the pressurized ion guide and configured to provide mass analysis of the received ions, and a controller in communication with said at least one pressurized ion guide for causing the adjustment of the axial field so as to switch the operational setting of the pressurized ion guide between the fast and the slow operational settings based on an operational mode of the mass spectrometer.

In some embodiments, the operational mode of the mass spectrometer is characterized by an inter-precursor switching time associated with analysis of different precursor ions introduced into the mass spectrometer during a single mass analysis run.

In some embodiments, the controller is configured to cause the ion guide to operate in the fast operational setting when said inter-precursor switching time is less than about 2 ms.

Further, in some embodiments, the controller is configured to cause the ion guide to operate in the slow operational setting when the inter-precursor switching time is greater than about 5 ms.

In some embodiments, the ion trapping device is configured to operate as a flow-through ion guide.

In some embodiments in which the trapping device operates as a flow-through ion guide (herein also referred to as a flow-through device), the controller can be configured to cause adjustment of the axial field such that ions passing through the pressurized ion guide during the fast operational setting of the ion guide remain substantially, and preferably entirely, unfragmented.

In various embodiments, including those in which the trapping device operates as a flow-through ion guide, the controller can be configured to cause the adjustment of the axial field in the slow operational setting of the ion guide so as to prevent saturation of an ion detector of the mass analyzer.

In various embodiments, including those in which the trapping device operates as a flow-through ion guide, the controller can be configured to cause adjustment of the axial field in the slow operational setting of the ion guide so as to prevent charge distortion effects in one or more mass spectra generated based on data acquired by the mass analyzer.

In various embodiments, the trapping device can be configured to operate as an ion trap to generate a plurality of temporally distinct ion packets. In some such embodiments, the default setting of the operational status of the ion guide can be set based on the timing of the generation of the ion packets. By way of example, in some such embodiments, the ion guide can be operated in a default slow operational setting except for a final set of ion packets, e.g., for the last ion packet, where the operational setting of the ion guide can be switched to the fast operational setting. For example, the controller can be configured to adjust the axial field so as to select the slow operational setting of the ion guide for one or more ion packets generated during a first data acquisition interval and to select the fast operational setting of the ion guide for one or more ion packets generated during a second data acquisition interval.

The mass spectrometer can include a DC voltage source operating under control of the controller for application of at least one DC voltage to the ion guide for generating the adjustable axial field. In some embodiments, the controller can be configured to apply a minimum DC voltage at which the axial field results in the ion packets arriving at the mass analyzer exhibiting a temporal spread (e.g., characterized by full width at half maximum (FWHM)) below a target threshold, e.g., 10 ms. Further, in some such embodiments, the applied voltage can be selected such that the ratio of a temporal gap between consecutive ion packets arriving at the mass analyzer relative to temporal spread (e.g., average temporal spread) of the ion packets is in a range of about 0 to about 5 ms. By way of example, the controller can be configured to determine the minimum DC voltage by successively increasing the DC voltage applied to the ion guide and monitoring the temporal spread of the ions arriving at the mass analyzer until a target temporal spread (e.g., a target average temporal spread) and/or a target ratio of the temporal gap between the consecutive ion packets and their temporal spread (e.g., their average temporal spread) is achieved.

In some embodiments, the ion guide can include a plurality of rods that are arranged in a multipole configuration, such as, a quadrupole, a hexapole, or an octupole configuration. In some such embodiments, RF voltages can be applied to the rods to cause radial confinement of the ions and DC voltage(s) can be applied to the rods to generate a desired axial potential within the ion guide.

In some embodiments, the mass spectrometer can include a ToF mass analyzer.

A variety of ion trapping devices can be employed in the practice of the present teachings. By way of example, the ion trapping device can be an ion-particle, an ion-ion, and an ion-radiation reaction device, such as an electron activated dissociation (EAD) device, a proton transfer device, a UV or an infrared dissociation device.

In some embodiments, the pressurized ion guide can be maintained at a pressure in a range of about 1 mTorr to about 10 mTorr.

In a related aspect, a method of performing mass spectrometry is disclosed, which includes sequentially introducing ions generated via ionization of a plurality of samples into an ion trapping device, introducing the ions exiting the ion trapping device into a pressurized ion guide configured to allow establishment of an adjustable axial field therein such that the axial field can be adjusted to switch the operational setting of the pressurized ion guide between at least a fast and a slow operational setting based on an operational mode of the mass spectrometer.

By way of example, the operational mode of the mass spectrometer can be characterized by an inter-precursor switching time associated with the consecutive mass analysis of different precursors during a single mass analysis run.

In some embodiments, the axial field can be adjusted so as to operate the pressurized ion guide in the fast operational setting when the inter-precursor switching time is less than about 2 ms and to operate the pressurized ion guide in the slow operational setting when the sample switching time is greater than 5 ms.

In some embodiments, the ion guide can operate as an ion flow-through ion guide in which the ions are not trapped, but rather pass through the ion guide while being subjected to, e.g., deceleration or acceleration. In some other embodiments, the ion guide can operate as an ion trap in which the ions are trapped and can be subjected to processes, such as, ion-particle, ion-ion, and ion-radiation reactions, that result in the generation of product ions.

As noted above, the ion trapping device can be operated as a flow-through ion guide or as an ion trap. In some embodiments including those in which the ion guide is operated as a flow-through device, the axial potential can be adjusted such that the ions passing through the ion trapping device remain substantially unfragmented. Further, in some embodiments, the axial potential can be adjusted when the ion guide is operated in the slow operational setting so as to prevent saturation of an ion detector of the mass analyzer. In some embodiments, including those in which the ion trapping device is operated as an ion flow-through device, the axial field can be adjusted so as to prevent occurrence of charge distortion effects in one or more mass spectra generated based on the data acquired by the mass analyzer.

As noted above, in some embodiments, the ion trapping device can be operated as an ion trap, e.g., to generate a plurality of temporally distinct ion packets, which can include product ions generated via processing of precursor ions introduced into the trap. In some such embodiments, the operational setting of the pressurized ion guide can be selected based on the timing of the generation of the temporally distinct ion packets. By way of example, in some such embodiments, the slow operational setting of the ion guide is selected for one or more ion packets generated during a first data acquisition interval and the fast operational setting of the ion guide is selected for one or more of the ion packets that are generated during a second data acquisition interval, where the second data acquisition interval follows the first data acquisition interval.

In a related aspect, a method of performing mass spectrometry is disclosed, which includes generating a plurality of ion packets in a plurality of distinct temporal periods, where each of the ion packets comprises product ions associated with the same precursor ion species, introducing each of the ion packets into a pressurized ion guide, and subjecting each of the ion packets to an axial potential in the pressurized ion guide. During a data acquisition period, each of the ion packets passing through the pressurized ion guide is introduced into a downstream time-of-flight (ToF) mass analyzer to generate ion detection signals corresponding to the ions in that ion packet, and adjusting the axial potential so as to decelerate at least a first ion packet generated in at least a first one of the temporal periods and to accelerate at least a second ion packet generated in at least a second one of the temporal periods, wherein the at least a second one of the temporal periods is subsequent to the at least a first one of the temporal periods.

In some cases, the at least a first one of the temporal periods overlaps with a first portion of the data acquisition period and the at least a second one of the temporal periods overlaps with a second portion of the data acquisition period, wherein the second portion of the data acquisition period is subsequent to the first portion of the data acquisition period. In some such embodiments, the second ion packet includes a plurality of temporally consecutive ion packets. In some cases, the temporally consecutive ion packets can include an ion packet generated in the final one of the plurality of distinct temporal periods. In some cases, the at least a second one of the ion packets includes the final one of the plurality of ion packets.

In some embodiments, each of the ion packets can be generated by trapping a precursor ion in an ion trap and subjecting the trapped precursor ion to an ion-particle, an ion-ion, or an ion-radiation reaction to generate the product ions. In some cases, the product ions can be generated via fragmentation of the precursor ion. In some embodiments, the reaction to which the ions are subjected can lead to the fragmentation of the trapped precursor ions to generate the product ions. By way of example, and without limitation, the reactions can include any of electron activated dissociation, ultraviolet photo dissociation, infrared multi photon dissociation, electron transfer dissociation, and proton transfer reaction.

In various embodiments, the pressurized ion guide can include a plurality of rods that are arranged in a multipole configuration, such as a quadrupole, a hexapole, or an octupole configuration. In some such embodiments, a first DC voltage is applied to at least one of the multipole rods to facilitate the generation of the axial DC potential. The pressurized ion guide can also include a plurality of auxiliary electrodes that are interspersed with the plurality of multipole rods. In some such embodiments, a second DC voltage can be applied to at least one of the auxiliary electrodes such that the combination of the first and the second DC voltages generates the axial DC potential.

In a related aspect, a method of performing mass spectrometry is disclosed, which includes generating a first plurality of ion packets during a first temporal period, where each of the ion packets comprises product ions associated with a first precursor ion species, introducing the first plurality of the ion packets into a pressurized ion guide, subjecting the first plurality of the ion packets to an axial DC potential in the pressurized ion guide so as to decelerate ions in the first plurality of the ion packets to generate a first plurality of decelerated ion packets. During a first data acquisition period, the first plurality of decelerated ion packets is introduced into a time-of-flight (ToF) mass analyzer to generate ion detection signals corresponding to those product ions. During a second temporal period, a second plurality of ion packets is generated, where each of the second plurality of the ion packets includes product ions corresponding to a second precursor species. The first data acquisition period overlaps partially with the second temporal period such that the data acquisition associated with the first plurality of decelerated ion packets continues during a portion of the second temporal period in which a subset of the second ion packets is generated.

During a second data acquisition period, the second plurality of ion packets is introduced into the TOF mass analyzer to generate ion detection signals associated with the product ions, e.g., fragment ions, in the second plurality of the ion packets. In some embodiments, the product ions in the second plurality of the ion packets are decelerated via passage through the pressurized ion guide before their introduction into the TOF mass analyzer.

In various embodiments, the step of generating the first plurality of the ion packets includes trapping the ions corresponding to the first precursor ion species and subjecting at least a portion of the trapped ions to an ion-particle, an ion-ion, or an ion-radiation reaction to generate the product ions. Further, the step of generating the second plurality of ion packets includes introducing the ions corresponding to the second precursor ion species into the ion trap and subjecting at least a portion of the trapped ions to an ion-particle, an ion-ion, or an ion-radiation reaction to generate the product ions. By way of example, the reaction can include any of electron activated dissociation, ultraviolet photo dissociation, infrared multi photon dissociation, electron transfer dissociation, and proton transfer dissociation.

Further understanding of various aspects of the present teachings can be obtained by reference to the following detailed description in conjunction with the associated drawings, which are described briefly below.

### BRIEF DESCRIPTION OF THE DRAWINGS

FIG. 1 depicts an example of a typical arrival time distribution for fragment ions generated vi an EAD reaction performed in an ion dissociation device,

FIG. 2 shows an example of an EAD spectrum of a singly charged lipid species, where the ratio of a typical fragment intensity to precursor intensity is less than 1/500,

FIG. 3 shows an example of unprocessed data acquired around a signal associated with a highly abundant precursor,

FIG. 4A shows an example of a mass spectrum of a sample acquired under a high flux condition,

FIG. 4B shows a mass spectrum of the same sample as that in FIG. 4A acquired under a low flux condition,

FIG. 4C shows a mass spectrum of the same sample obtained under a “slow” ion propagation condition,

FIG. 4D shows a mass spectrum of the same sample obtained under a “fast” ion propagation condition,

FIG. 4E shows distribution of arrival times of a plurality of ion packets at a ToF mass analyzer,

FIG. 5A is a flow chart depicting various steps of a method for performing mass spectrometry according to an embodiment of the present teachings,

FIG. 5B shows an example of a timing diagram associated with an implementation of the mass spectrometry method discussed in connection with the flow chart of FIG. 5A,

FIG. 6A is a partial schematic view of an ion guide suitable for use in various embodiments, which includes a set of quadrupole rods and a plurality of auxiliary electrodes interspersed between those rods,

FIG. 6B is a partial schematic view of an ion guide suitable for use in various embodiments, which includes segmented quadrupole rod sets to which RF and DC voltages can be applied,

FIG. 6C is a partial schematic view of an ion guide suitable for use in various embodiments, which includes a plurality of stacked rings to which DC voltages can be applied for generate a DC axial potential,

FIG. 6D is an example of a traveling voltage wave that can be employed for decelerating or accelerating ions as they pass through an ion guide according to the present teachings,

FIG. 7 is a flow chart depicting various steps of a method according to an embodiment of the present teachings,

FIG. 8A is a timing diagram for processing ions in an embodiment of the present teachings,

FIG. 8B is a timing diagram for processing ions in an embodiment of the present teachings,

FIG. 9A schematically depicts a mass spectrometer according to an embodiment of the present teachings,

FIG. 9B is a partial view of the mass spectrometer depicted in FIG. 9A,

FIG. 9C is a diagram depicting examples of a conventional axial DC potential and an axial DC potential according to an embodiment generated in various components of the mass spectrometer depicted in FIGS. 9A and 9B,

FIGS. 10A, 10B, 10C, and 10D show arrival time distributions for a plurality of temporally distinct ion packets generated in an EAD cell as they arrive at a TOF mass analyzer that is positioned downstream of the EAD cell, where L1 stands for LINAC 1 (pulling ions) and L2 stands for LINAC 2 (pushing ions), illustrating that a slower axial gradient (smaller L2) results in a larger temporal spread in the ion packet, and

FIG. 11 is a diagram depicting an example of an implementation of a controller suitable for use in the practice of the present teachings.

### DETAILED DESCRIPTION

It will be appreciated that for clarity, the following discussion will explicate various aspects of embodiments of the applicant's teachings, while omitting certain specific details wherever convenient or appropriate to do so. For example, discussion of like or analogous features in alternative embodiments may be somewhat abbreviated. Well-known ideas or concepts may also for brevity not be discussed in any great detail. The skilled person will recognize that some embodiments of the applicant's teachings may not require certain of the specifically described details in every implementation, which are set forth herein only to provide a thorough understanding of the embodiments. Similarly, it will be apparent that the described embodiments may be susceptible to alteration or variation according to common general knowledge without departing from the scope of the disclosure. The following detailed description of embodiments is not to be regarded as limiting the scope of the applicant's teachings in any manner.

As used herein, the terms “about” and “substantially equal” refer to variations in a numerical quantity that can occur, for example, through measuring or handling procedures in the real world; through inadvertent error in these procedures; through differences in the manufacture, source, or purity of compositions or reagents; and the like. Typically, the terms “about” and “substantially” as used herein means 10% greater or lesser than the value or range of values stated or the complete condition or state. For instance, a concentration value of about 30% or substantially equal to 30% can mean a concentration between 27% and 33%. The terms also refer to variations that would be recognized by one skilled in the art as being equivalent so long as such variations do not encompass known values practiced by the prior art.

As used herein the term “and/or” includes any and all combinations of one or more of the associated listed items and may be abbreviated as “/”.

The term “ion trapping device,” as used herein, refers to a device that can receive ions and can subject the ions to electric and/or electromagnetic fields, e.g., for causing their radial confinement and/or adjusting their kinetic energies, and from which those ions and/or product ions thereof can exit. An ion trapping device can be operated in a flow-through mode (herein also referred to as a pass-through mode) in which the ions remain substantially intact (e.g., unfragmented) as they pass through the ion trapping device. Alternatively, an ion trapping device can be operated as an ion trap in which ions can be temporarily trapped and optionally subjected to a reaction, such as an ion-particle, an ion-ion and/or an ion-radiation reaction, to generate product ions, e.g., fragment ions.

The term “electron activated dissociation,” and its abbreviation “EAD,” as used herein, refers to an electron mediated process that leads to dissociation of a species. Some examples of EAD reactions include electron capture dissociation (ECD), such as hot ECD, negative ECD, electron impact dissociation (EID), electron impact excitation of ions from organics (EIEIO), and electron detachment dissociation for both positively and negatively charged precursor ions.

An in-spectrum dynamic range is an important characteristic of a mass spectrometer and is defined as the ratio of the lowest detectable mass signal to the highest detectable mass signal in a single spectrum. In a time-of-flight (ToF) mass analyzer, the lowest signal intensity that can be detected is limited by the noise level while the highest signal intensity that can be detected is often limited by the number of ions that can be concurrently detected in a single ion detection event. Further, the frequency of ToF extractions performed by a ToF mass analyzer is generally very high (e.g., greater than 10 kHz) compared to a typical ion accumulation time (e.g., in an ion trap) of about 10 ms. For example, in some such situations, each ToF spectrum may contain at least 100 ToF extractions with the upper limit of detection being correlated to a maximum number of ions the detection system can handle multiplied by the number of ToF extractions.

However, in certain cases, the number of ToF extractions containing mass signal is not equal to the total number of ToF extractions. In other words, in certain cases, not every ToF extraction includes a mass signal. In such cases, the multiplier associated with the number of ToF extractions corresponds to the number of ToF extractions containing mass signal(s). By way of example, such situations can occur when ions are trapped and released prior to the mass analysis in a ToF mass analyzer since the frequency of trap/release cycle is often much lower than the ToF analyzer speed.

Such trap/release arrangements are particularly useful in MS/MS analysis, where an analyte can be interrogated via ion-ion, ion-particle and/or ion-radiation reactions, such as ultraviolet photo dissociation (UVPD), infrared multi photon dissociation (IRMPD), electron activated dissociation (EAD), electron transfer dissociation (ETD), and proton transfer reaction (PTR). In such cases, the effective number of ToF pulses will be mostly defined by the trap/release cycle frequency, which can in turn hamper the in-spectrum dynamic range. The necessity for prolonged reaction times can stem from typically inherently poor fragmentation/reaction efficiency in such fragmentation techniques. Consequently, in-spectrum dynamic range in such cases is often lower than in beam type collision induced dissociation techniques or cases where no fragmentation takes place, such as ToF MS acquisition.

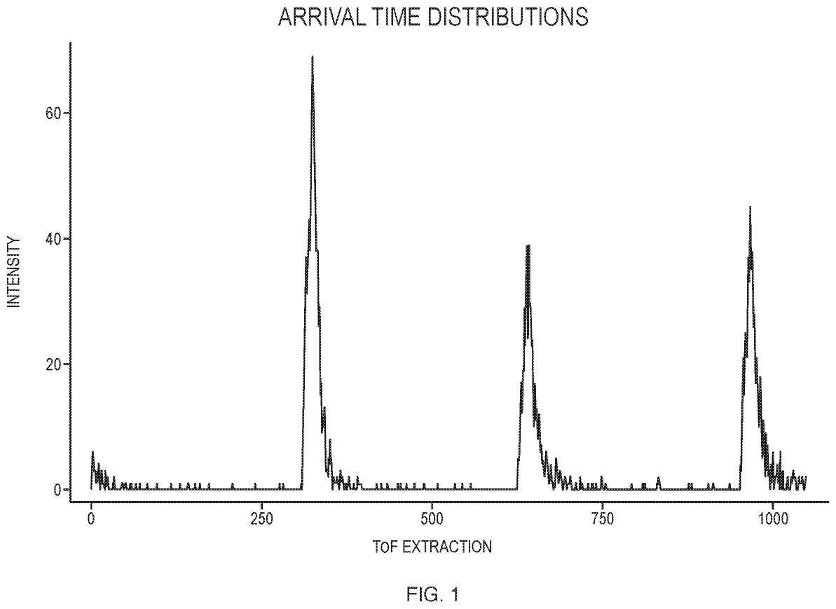

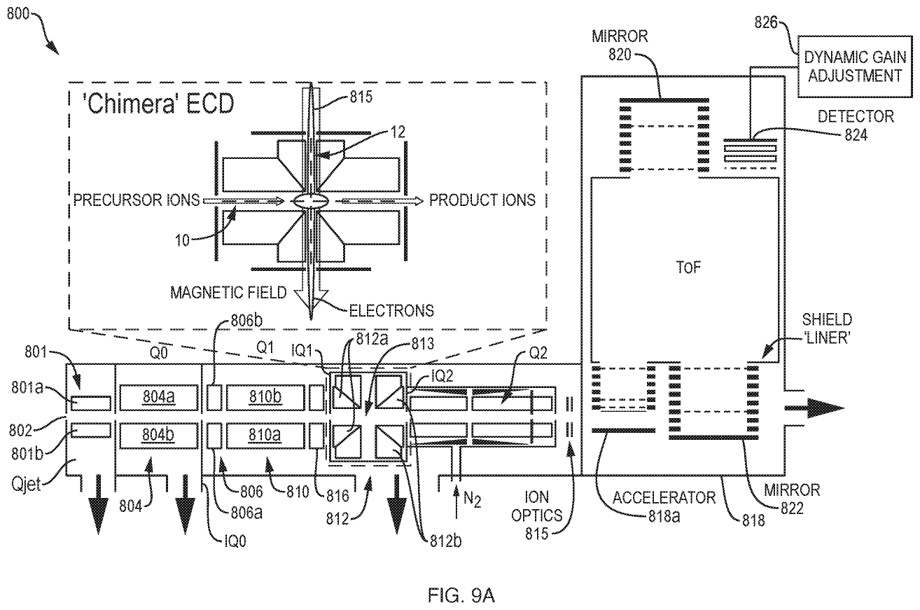

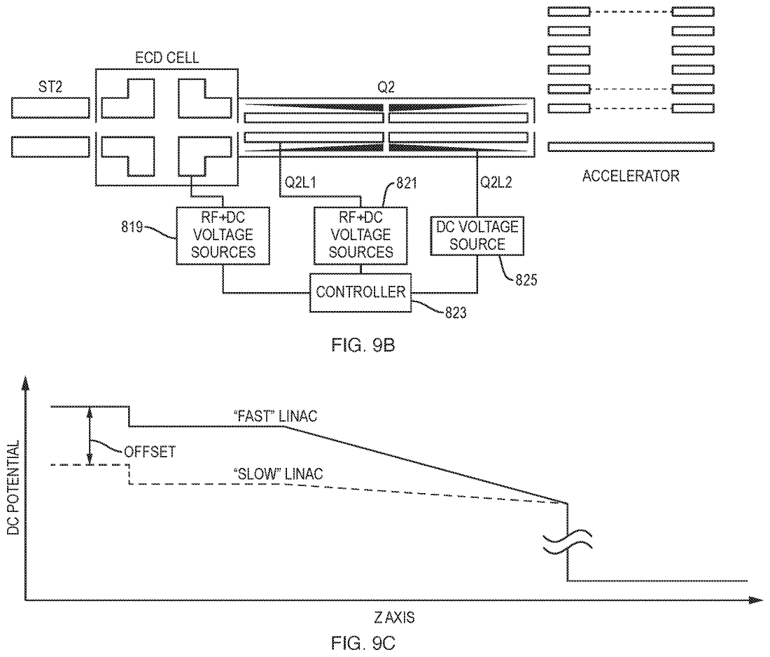

By way of illustration, FIG. 1 depicts a typical arrival time distribution for fragment ions generated via an EAD reaction performed in an ion dissociation device at a downstream ToF mass analyzer. The data was obtained using a mass spectrometer as shown schematically in FIGS. 9A and 9B, which are described in more detail below. In this example, singly charged ions underwent a 30-ms simultaneous loading and reaction and the ToF mass analyzer was pulsed at 13.5 kHz frequency. In this example, less than 30% of ToF extractions contained any signal with 90% of the total signal contained in about 10% of the ToF extractions.

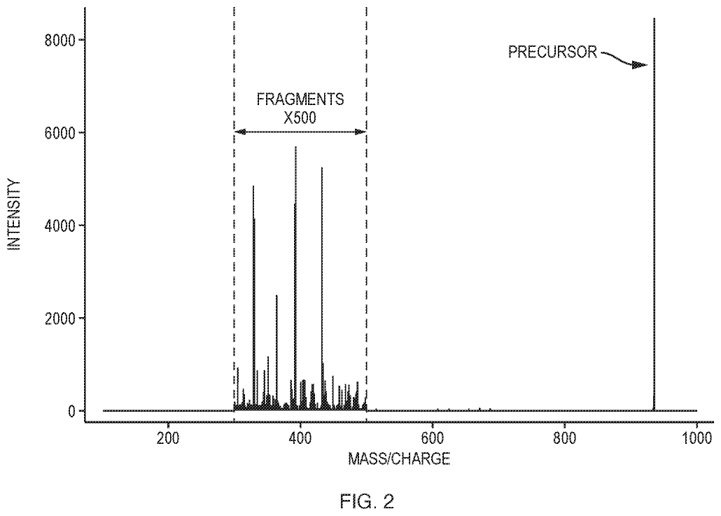

In certain fragmentation techniques, such as EAD, the total number of possible fragment ion types can be high. Further, in EAD, the interrogation of singly charged ions may result in precursor and fragment neutralization reactions, which can lead to a high ratio of the remaining precursor ions relative to fragment ions under optimal reaction conditions. In case of multiply charged ions, in addition to product neutralization, secondary fragmentation may occur, which leads to uninformative internal fragment ions. Such discrepancy in precursor-to-fragment abundance can further exacerbate the difficulty for in-spectrum dynamic range adjustments since both the intense remaining precursor and low intensity fragment ions need to be co-detected. By way of illustration, FIG. 2 shows an example of an EAD spectrum of a singly charged lipid species, where the ratio of a typical fragment intensity to precursor intensity is less than 1/500. Such discrepancy in precursor-to-fragment abundance can further exacerbate the potential problems associated with a limited in-spectrum dynamic range.

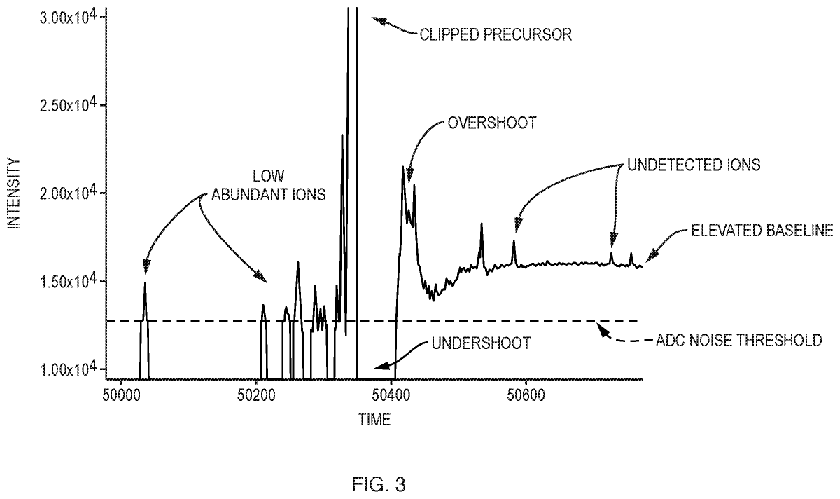

One drawback of inherently poor in-spectrum dynamic range associated with EAD is that data acquisition under very high ion loads, which is typically preferable for facile detection of low abundant fragment ions, can lead to undesirable data artifacts. By way of illustration, FIG. 3 shows an example of unprocessed data acquired around a signal associated with a high abundant precursor, which exhibits clipped precursor signal, followed by an undershoot zone of silence (no detected signals) and followed by a significantly elevated baseline, which stays above threshold for more than 10 microseconds. The latter problem (clipped precursor signal) can arise in conventional data acquisition systems that are tuned for very high data rates and often includes a data filtering as a first data processing step. Such data filtering can be used to detect data points above a threshold and form a data packet from those data points, often supplementing the data packet by a finite number of adjacent points. Conventionally, such a data packet is associated with a single detection event, which would ideally correspond to the detection of an ion or a group of ions from the same precursor ion species.

An example of such a data packet is marked as low abundant ions in FIG. 3. Such conventional data processing, however, poses challenges for processing data with an elevated baseline, where wide transferred packets can contain multiple detection events. In addition, the recovery of the elevated baseline can generate noise peak artefacts, for example, at points where the baseline slowly crosses a discriminator's threshold. Both phenomena can lead to undesirable data artefacts.

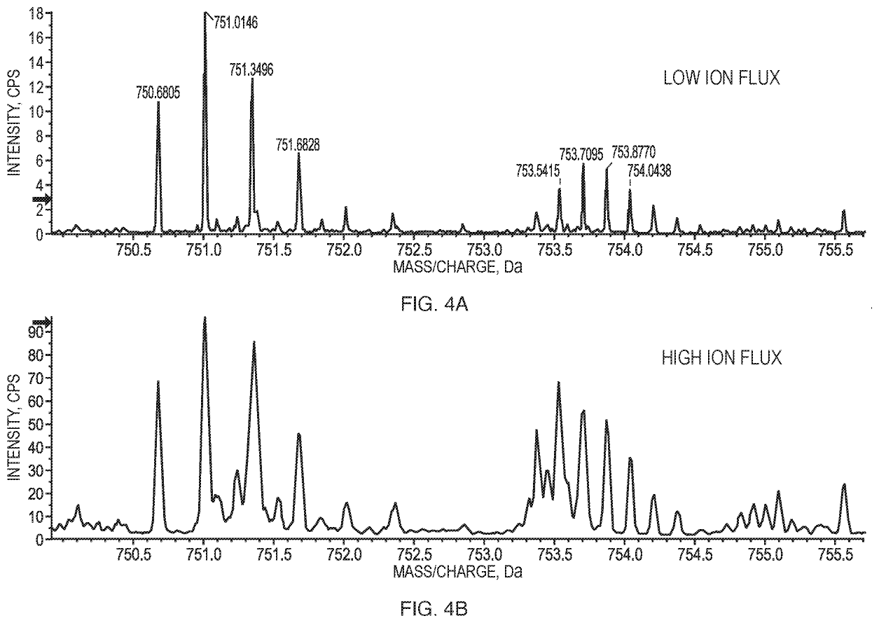

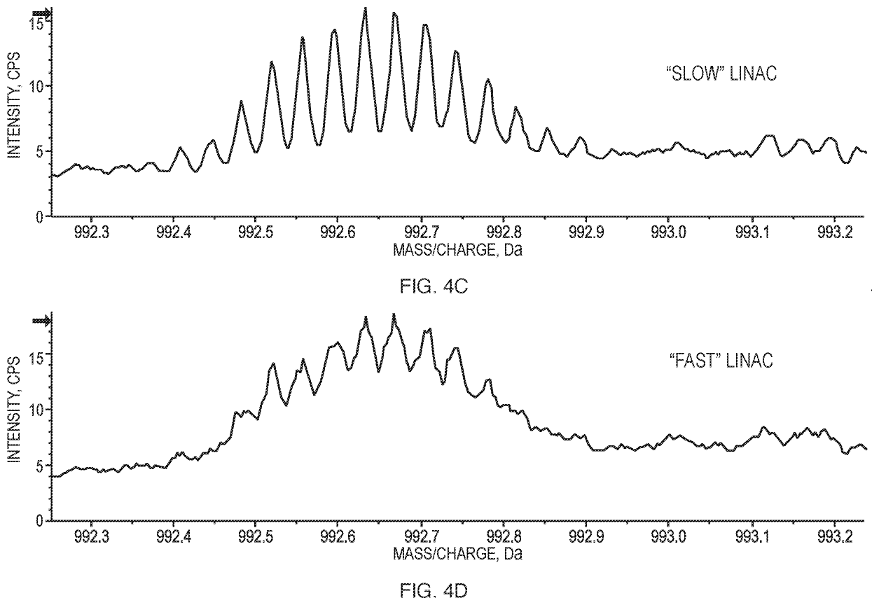

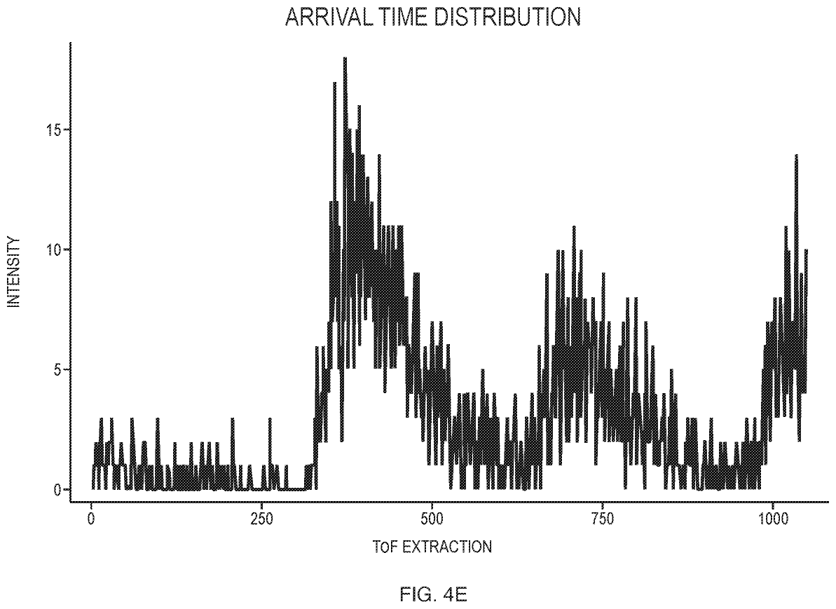

Another problem can arise in EAD (or any other trapping techniques) MS/MS analysis of highly charged proteins, where the total ion charge can degrade the performance of a mass analyzer when exceeding a threshold. FIGS. 4A and 4B show an example of such a phenomenon where the mass spectra for the same sample were obtained under both high and low ion flux conditions. The mass spectra that originated from high ion flux conditions shows a significant peak broadening.

It has been discovered that the inhomogeneity of an ion beam when performing MS/MS analysis, e.g., via EAD fragmentation of the precursor ions, may be a cause of such problems. Conventionally, fragment ions are accelerated as they pass through a downstream pressurized ion guide, e.g., a collision cell (such as the Q2 cell discussed below), by an axial DC potential. In various embodiments, a typical pressure within such a pressurized ion guide can be in a range of about 1 to about 10 mTorr, by way of example.

One way of addressing such inhomogeneity is to slow down the ions in a region between ion trapping and ToF mass analyzer. By way of example, the “slow down” of the ions can be achieved by applying either neutral, reverse or slightly forward voltages to a pair of tapered electrodes (herein also referred to as LINAC electrodes) and matching potentials on the other elements, e.g., in a manner discussed in more detail below. Here the reverse voltages generate an axial potential in an opposite direction to the ion movement, while the neutral voltages do not generate any axial potential and slightly forward voltages generate an axial potential along the ion movement, which can be no more than ⅓ of a typical axial potential corresponding to “forward” voltages. For example, a slightly forward potential will correspond to a total voltage drop of less than 1V over an ion guide. By way of example, FIGS. 4C and 4D show examples of mass spectra acquired under slow and fast ion conditions for the propagating ions. The data acquired under slow ion propagation shows better quality (e.g., narrower linewidths) than the data acquired under a fast ion propagation condition. A similar strategy can also work for mitigation of space charge effects for MS/MS analysis of highly charged proteins.

However, one drawback of such an approach, i.e., reducing the propagation speed of the ions, is that it can adversely affect the throughput of the system. For example, complex mixtures are often analyzed using LC/MS (liquid chromatography/mass spectrometry) techniques. In such analyses, thousands of analytes need to be analyzed over a short period, e.g., in each minute of the analysis. Since a conventional mass spectrometer is a sequential device, the analysis of thousands of analytes requires scheduling separate time intervals for analysis of co-eluting analytes. A mass spectrometry experiment measuring ions corresponding to one or more such analytes is sometimes called a transition, following the nomenclature of targeted MRM analysis, where each precursor has a transition to a product ion and such transition is monitored. It is convenient to expand this terminology to other conventional mass spectrometry analyses, such as data-dependent analysis or data independent analysis. In many situations, it is important to ensure that the crosstalk between the transitions is negligible (e.g., <1%, which indicates that the ions from a transition has a contribution of less than 1% to an analysis associated with a subsequent transition).

In order to achieve such an objective, after the conclusion of data acquisition for one transition, the ion guides of the mass spectrometer are often cleared of the remaining ions corresponding to this transition. The next acquisition starts following some ion refill period.

Generally, the time required for an ion optic to equilibrate is an undesired overhead, which reduces the total number of possible measured transitions. To reduce such an overhead, different parts of an ion optic are configured to drive the ions as fast as possible while maintaining the integrity of the ions being transmitted. Pressurized ion guides in which ions tend to lose their kinetic energy owing to collisions with the bath gas are recognized as bottlenecks for fast ion movement.

In some pressurized ion guides, an axial DC gradient is established to assist the ion motion along the ion guide. A transient time of the order of 1 ms has been observed for some such fast ion guides, which can result in a total switching time of less than 2 ms between the transitions. Such a gradient is often set in smooth increments to prevent ions from acquiring high kinetic energy, which upon collision with the bath gas can lead to ion fragmentation and hence ion loss. This contrasts with other approaches, such as changing collision energy at the entrance of the pressurized ion guide, which leads to ion fragmentation and is often employed to assist with the transition from a precursor ion to a product ion.

Conventionally, based on the recognition of the need to drive ions as fast as possible, but without unwanted fragmentation, modern mass spectrometers employ fast axial DC gradients, i.e., DC gradients that speed up the motion of the ions. Such an approach can, however, lead to potential loss of sensitivity and degradation of data quality, e.g., due to a reduction in the in-spectrum dynamic range.

It has been recognized in the present disclosure that it is advantageous to operate a pressurized ion guide of a mass spectrometer in a slow operational setting in at least a portion of data acquisition period associated with mass analysis to provide a significant improvement of data quality, albeit at the expense of some increase in the overhead time, especially for mass analyses in which the ions are trapped prior to analysis. By way of example, and without limitation, in some embodiments, the transient time in the slow operational setting of the pressurized ion guide can be between about 5 and about 20 ms, which can aid in ion packet spread and providing more favorable detection conditions. In various embodiments, a typical pressure within such a pressurized ion guide can be in a range of about 1 to about 10 mTorr, by way of example.

By way of example, FIG. 4E shows a plurality of ion packets detected via a ToF mass analyzer where the ion packets were decelerated during their passage through a collision cell. The last ion packet was only partially captured and a longer data acquisition period would have been required to detect the entirety of the last ion packet. As discussed below, in some embodiments, the last ion packet can be accelerated to prevent loss of mass data due to incomplete detection (or lack of detection) of the ion packet.

As discussed in more detail below, in various embodiments, an axial DC potential within a collision cell disposed downstream from an ion fragmentation device can be switched between an ion-decelerating potential and an ion-accelerating potential in synchrony with cycles of fragmentation of precursor ions of a particular species, e.g., to provide enhanced dynamic range and throughput.

For example, in some such embodiments in which a series of ion packets corresponding to a particular precursor ion species are generated, all of the ion packets except for the last one in the series can be decelerated and the last ion packet can be accelerated to improve both the dynamic range as well as the throughput of the system.

In some embodiments, the data acquisition cycles can be offset relative to respective fragmentation cycles, in combination with the deceleration of the ion packets, to improve both the system's dynamic range and its throughput.

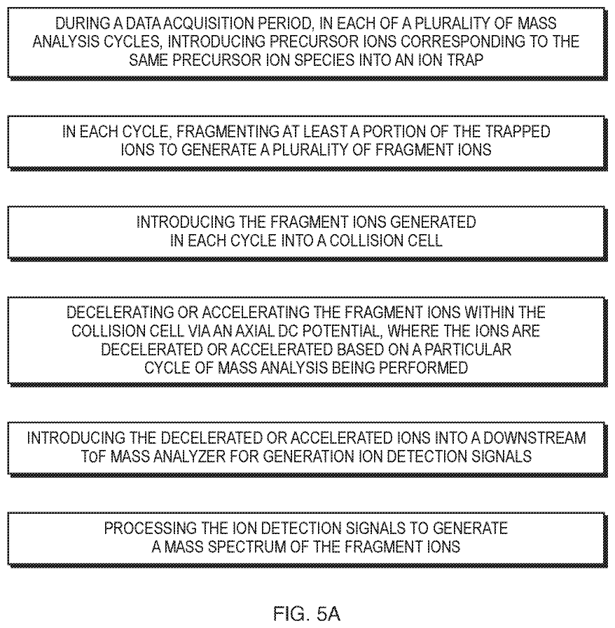

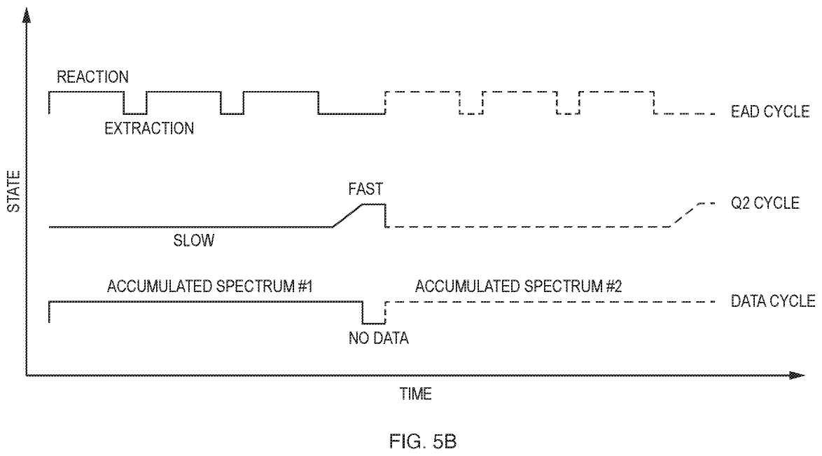

With reference to the flow chart of FIG. 5A, in one embodiment of a method according to the present teachings for performing mass spectrometry, ions corresponding to a precursor ion species (i.e., ions of the same precursor ion species) can be mass analyzed through a plurality of mass analysis cycles of trapping a portion of the ions in an ion trap, causing fragmentation of the trapped ions to generate a plurality of fragment ions, decelerating or accelerating the fragment ions through a pressurized ion guide, e.g., a collision cell, and introducing the decelerated/accelerated ions into a time-of-flight (ToF) mass analyzer to generate ion detection signals during a data acquisition period (herein also referred to as a data acquisition interval), where the ion detection signals can be processed to generate a mass spectrum of the ions.

In various embodiments, the deceleration or acceleration of the ions as they pass through the pressurized ion guide can be achieved via an axial DC potential generated within the pressurized ion guide. In some embodiments, such an axial DC potential can be adjusted to transition from an ion-decelerating potential to an ion-accelerating potential during one or more terminal cycles of mass analysis of the precursor ion species. By way of example, the default setting of the axial DC potential can be a decelerating DC potential to “slow down” the ions introduced into the pressurized ion guide. The axial DC potential can be switched to an accelerating DC potential during one or more terminal cycles of mass analysis. By way of example, the axial DC potential can be switched to an accelerating DC potential during the last (final) cycle of mass analysis, e.g., in order to ensure that the fragment ions generated during the final cycle will reach the downstream ToF mass analyzer prior to the termination of the data acquisition period.

By way of example, and without limitation, the decelerating axial DC potential can be in a range of about 0 to about 2 volts across the ion guide and the accelerating axial DC potential can be in a range of about 3 volts to about 5 volts and can have an opposite polarity relative to the decelerating axial DC potential. In some embodiments, the deceleration of the ion fragments can be achieved primarily via their collisions with molecules of a background gas present in the pressurized ion guide (e.g., a collision cell) while in some other embodiments, an axial electric field associated with the axial DC potential is the primary mechanism for decelerating the ions. In the latter case, in various embodiments, collisions with bath gas or widening due to space charge are responsible for spreading the ion packet.

FIG. 5B shows an example of a timing diagram associated with an implementation of the method discussed above in connection with FIG. 5A. The timing diagram shows that in each data acquisition cycle, a plurality of ion packets generated during a first portion of the data acquisition cycle are decelerated, i.e., they are slowed down, whereas the last ion packet is accelerated so as to avoid incomplete collection of the data associated with that ion packet, thus improving the dynamic range while increasing the system's throughput.

In some embodiments, the pressurized ion guide, e.g., a collision cell, can include a plurality of rods that are arranged according to a multipole configuration, e.g., a quadrupole configuration. By way of example, a voltage offset between the multipole rods and the rods associated with an upstream ion trap can be employed to establish an axial DC potential within the pressurized ion guide. By way of example, the upstream ion trap can be an electron dissociation cell that includes a pair of L-shaped electrodes that are offset axially relative to one another to form an ion trap region therebetween within which ions can be trapped and undergo fragmentation (e.g., via electron activated dissociation).

A DC voltage source operating under the control of a controller can generate a DC offset voltage between the rods of the pressurized ion guide and those of the upstream ion trap to cause deceleration or acceleration of the ions entering the collision cell. Further, as discussed in more detail below, a pair of longitudinally tapered auxiliary electrodes (herein also referred to as LINAC electrodes) can also be positioned in the pressurized ion guide. A voltage offset applied between the two pairs of the LINAC electrodes can also contribute to the generation of the axial DC potential within the pressurized ion guide. In other words, the offset voltage between the rods of the pressurized ion guide and those of the upstream ion trap as well as the voltage across the pair of the LINAC electrodes can cooperatively generate the axial DC potential within the pressurized ion guide. In various embodiments, the adjustment of the DC offset voltage between the rods of the pressurized ion guide and those of the upstream ion trap, rather than the DC offset voltage between the pairs of the LINAC electrodes, is employed to adjust the axial DC potential within the pressurized ion guide so as to transition the axial DC potential between a decelerating and an accelerating potential.

In some other embodiments, other types of ion guides can be employed, such as segmented multipole, stacked ring ion guides, or ion guides having segmented set of auxiliary electrodes. In some embodiments the axial field is generated by applying various DC potentials to each segment or ring electrode. In some other embodiments the ions are propelled either towards the mass analyzer or in reverse by applying travelling wave to said segments of the ion guide.

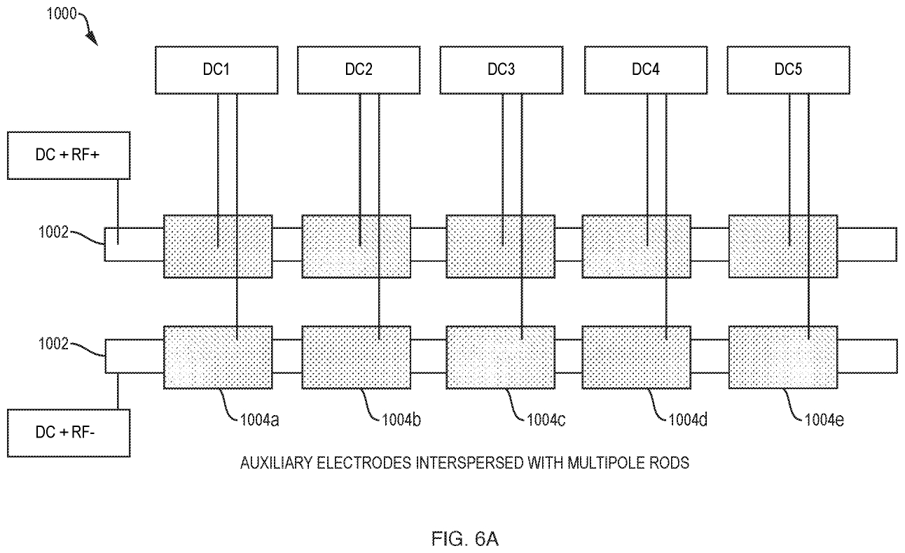

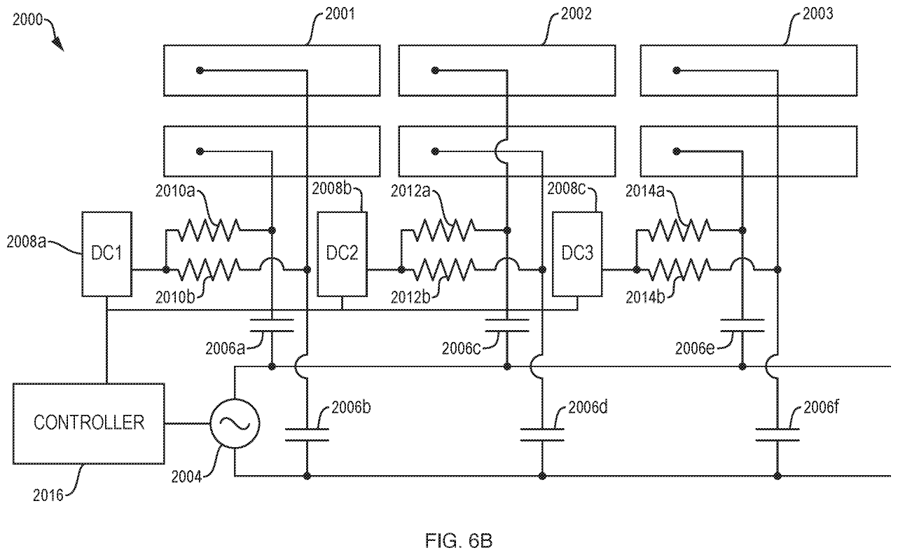

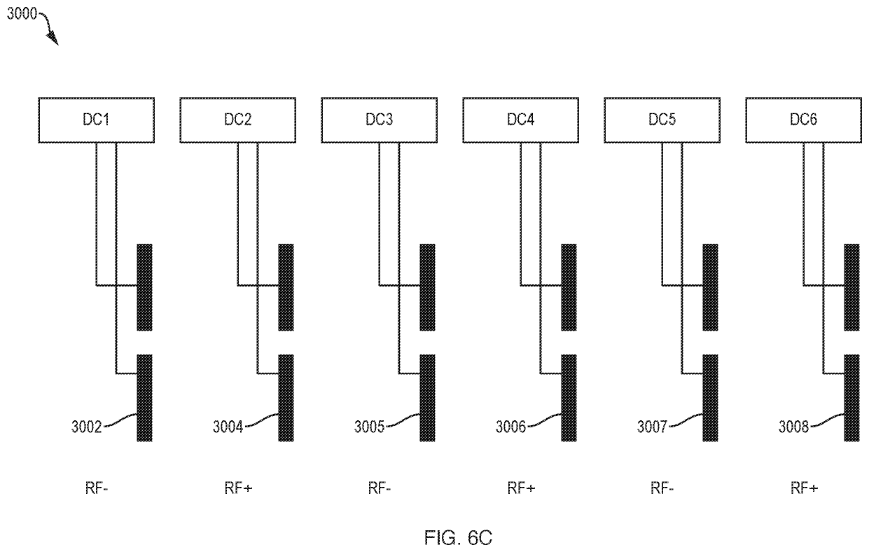

For example, FIG. 6A is a partial schematic view of an ion guide 1000 according to an embodiment, which includes a set of quadrupole rods 1002 (two of which are visible in the figure) to which RF voltages can be applied for generating a radial confinement field for ions passing through a passageway provided between the quadrupole rods. The ion guide 1000 further includes five pairs of auxiliary electrodes 1004a, 1004b, 1004c, 1004d, and 1004e that are interspersed between the quadrupole rods and are pair-wise axially separated from one another and to which DC voltages can be applied so as to generate a field gradient along the longitudinal axis of the ion guide for accelerating or decelerating ions passing through the ion guide. More specifically, in this example, a plurality of DC voltage sources (DC1, DC2, DC3, DC4, and DC5) supply different DC voltages to the auxiliary electrode pairs such that the DC potential difference between those electrode pairs generates the DC axial potential.

By way of further illustration, FIG. 6B shows an example of a segmented quadrupole ion guide 2000 that can be employed in a pressurized ion guide in various embodiments of the present teachings. The segmented quadrupole ion guide 2000 includes three quadrupole rod sets 2001, 2002, and 2003, that are disposed in series relative to one another so that they share a common longitudinal axis. More specifically, each quadrupole rod set includes four rods arranged in a quadrupole configuration. A plurality of axial gaps separates each quadrupole rod set from a neighboring one. In this embodiment, the axial gaps between the neighboring quadrupole rod sets are uniform while in other embodiments, the gaps can be non-uniform (i.e., they can have different values). In some embodiments, the gaps can be, for example, in a range of about 0.1 mm to about 10 mm.

A radiofrequency (RF) source 2004 is capacitively coupled via capacitors 2006a, 2006b, 2006c, 2006d, 2006e and 2006f to the rods of the quadrupole rod sets 2001, 2002, and 2003 to apply RF voltages thereto. In some embodiments, the RF voltages applied to the rods of the quadrupole rod sets can have a frequency, for example, in a range of about 200 kHz to 10 MHz and an amplitude in a range of about 100 V to about 10 kV.

Further, in this embodiment, a plurality of DC voltage sources 2008a, 2008b, 2008c are coupled electrically to the rods of the rod sets via resistors 2010a/2010b, 2012a/2012b, 2014a/2014b. The DC voltage sources can apply DC voltages to the rods of the quadrupole rod sets, for example, to modulate the energy of the electrons within the interaction module. In some embodiments, the DC voltages applied to the rods of the rod sets can be, for example, in a range of about 0 to about 100 volts (in embodiments in which negative ions are interrogated, negative voltages are utilized). Further, DC voltages can be applied to the electrodes 2001 and 2003 to help trap ions within the electron-ion interaction module.

A controller 2016 in communication with the RF source 2004 and the DC voltage sources can control the application of the RF and/or DC voltages to the rods of the quadrupole rod sets. For example, the controller 2016 can control the application of RF voltages to the rods of the quadrupole rod sets such that the phase of a voltage applied to any rod of the rod sets is opposite to the phase of the RF voltage applied to a respective rod of a neighboring rod set.

By way of another example, FIG. 6C shows an ion guide 3000 that includes a plurality of stacked rings 3002, 3003, 3004, 3005, 3006, 3007, 3008, each of which has a central opening through which the ions can pass. RF voltages are applied to the ion rings such that the RF voltages applied to two neighboring ion rings are 180 degrees out of phase relative to one another. Further, a plurality of DC voltage sources DC1, DC2, DC3, DC4, DC5 and DC6 apply DC voltages to the ion rings so as to generate an axial potential for accelerating or decelerating the ions passing through the openings of the ion rings.

In yet another example shown schematically in FIG. 6D, a traveling wave voltage applied to a plurality of electrodes (e.g., the rings discussed above) can be used to accelerate or decelerate ions passing through an ion guide.

In some embodiments, during a data acquisition period associated with a particular precursor ion species, the ions are accelerated only during the final cycle of mass analysis associated with a particular precursor ion species. In some such embodiments, the ions (i.e., the fragment ions and any residual precursor ions that may remain after fragmentation) are decelerated, i.e., their propagation speed is reduced, during one or more mass analysis cycles associated with a portion of the data acquisition period extending from the initiation of the data acquisition period to a terminal portion of the data acquisition period during which one or more terminal cycles of mass analysis are performed. By way of example, in various embodiments, the default setting of the axial DC potential is such that the ions are decelerated as they pass through the collision cell, where the default setting is changed for the final cycle (the last cycle) of mass analysis of the precursor ion species under analysis so as to accelerate the ions (fragment ions and any residual precursor ions) in that final cycle.

In various embodiments, subsequent to the termination of a data acquisition period for mass analysis of a precursor ion species, another data acquisition period for mass analysis of another precursor ion species is initiated in which multiple cycles of mass analysis are performed in a manner discussed above.

In a related aspect, a method of performing mass spectrometry is disclosed in which data acquisition periods associated with the detection of fragment ions of different precursor ion species are offset relative to cycles of fragmentation of those precursor ion species, e.g., to enhance data acquisition efficiency. By way of example, in some such methods, the data acquisition for the detection of the fragment ions associated with one precursor ion species continues while fragment ions associated with a different precursor ion species are being generated.

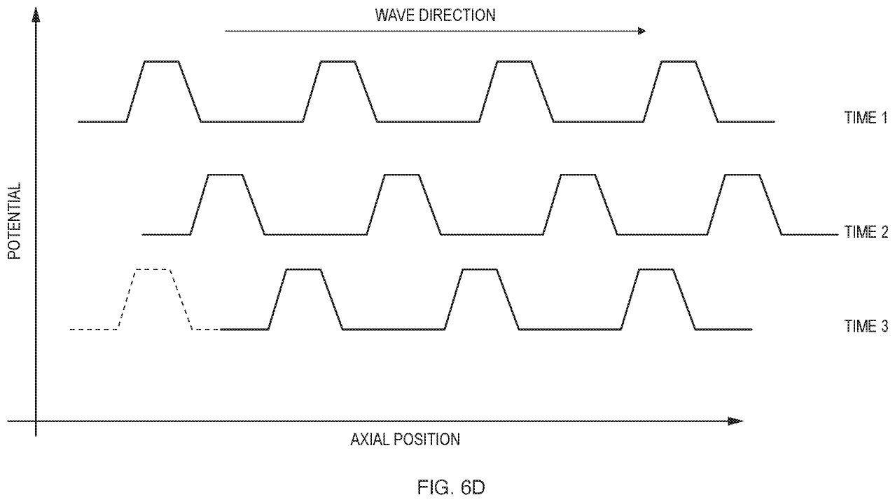

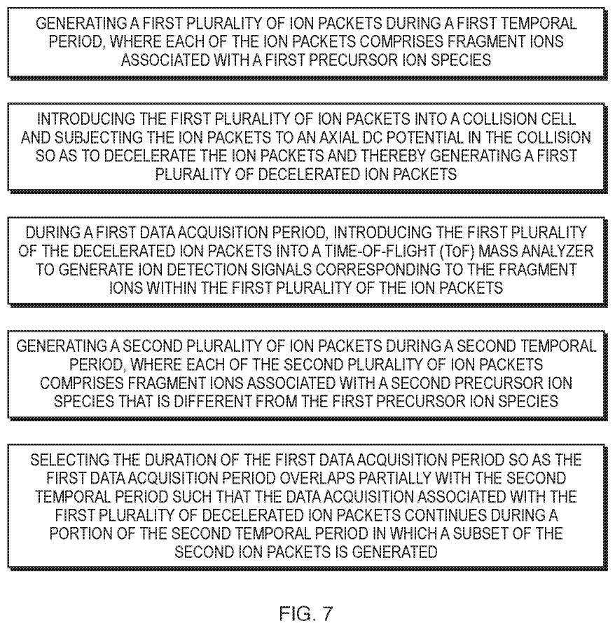

With reference to the flow chart of FIG. 7, in one embodiment of such a method for performing mass spectrometry, a first plurality of ion packets is generated during a first temporal period, where each of the ion packets comprises fragment ions associated with a first precursor ion species. The first plurality of ion packets is introduced into a collision cell and is subjected to an axial DC potential in the collision cell so as to decelerate ions in the ion packets and thereby generate a first plurality of decelerated ion packets.

During a first data acquisition period, the first plurality of the decelerated ion packets is introduced into a time-of-flight (ToF) mass analyzer to generate ion detection signals corresponding to the fragment ions within the first plurality of ion packets.

A second plurality of ion packets is generated during a second temporal period, where each of the second plurality of ion packets comprises fragment ions associated with a second precursor ion species that is different from the first precursor ion species.

The first data acquisition period overlaps partially with the second temporal period such that the data acquisition associated with the first plurality of decelerated ion packets continues during a portion of the second temporal period in which a subset of the second ion packets is generated. By way of example, the first data acquisition period associated with the first plurality of ion packets can continue while another precursor ion species is undergoing fragmentation. In other words, in various embodiments of this aspect of the present teachings, the data acquisition period associated with a precursor ion species, that is, the data acquisition period during which fragment ions associated with a precursor ion species are detected, in not co-terminus with the period in which the fragment ions are generated.

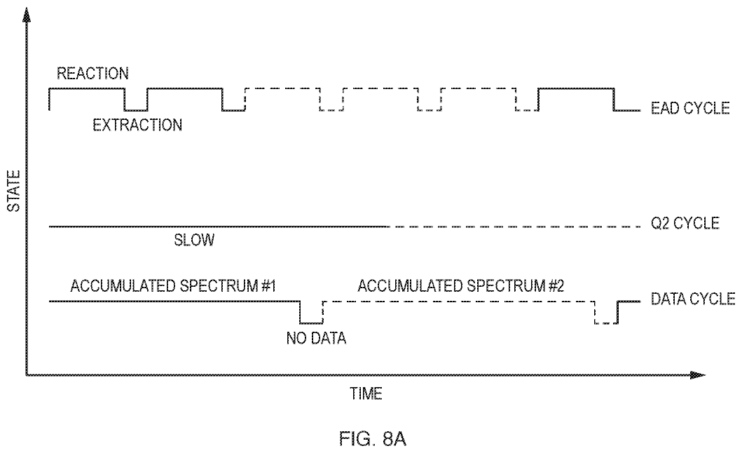

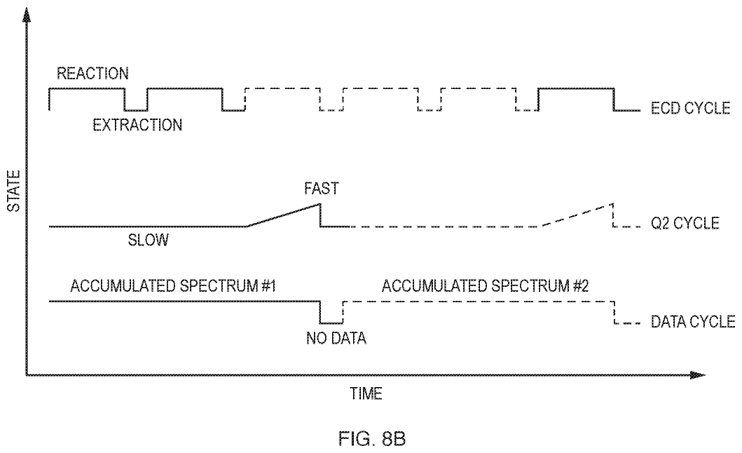

By way of further illustration, FIG. 8A provides an example of a timing diagram associated with one implementation of the above method of offsetting the data acquisition period relative to cycles of precursor ion fragmentation and introduction of the fragment ions into a downstream ToF mass analyzer in an MS/MS analysis of a plurality of different precursor ion species. In this example, multiple distinct groups of precursor ions are analyzed. The solid and dashed lines indicate which group of ions is processed in respective portions of a data acquisition period. In such embodiments, a fragmentation device (e.g., an EAD) is positioned upstream of a collision cell and a ToF mass analyzer, and hence it can be switched to receive the next group of ions while the processing (e.g., deceleration and/or detection) of the ions released from the fragmentation device in the previous cycle continues in parallel.

The portion of the trace labeled as EAD cycle and depicted via solid lines shows the time period corresponding to a plurality of cycles of fragmentation of a precursor ion species within an ion trap and their extraction from the ion trap to be introduced into a collision cell (e.g., the Q2 collision cell described below) and subsequently into a ToF mass analyzer. The trace depicted as dashed lines, in turn, shows respective cycles of fragmentation, collision cell introduction, and detection via a downstream ToF mass analyzer for a different precursor ion species. The solid line following the dashed line indicates another (third) precursor.

As the second trace labeled “Q2 cycle” shows, in all cases, the ions that are introduced into the collision cell are decelerated via an axial DC potential present within the collision cell, e.g., in a manner discussed herein.

The last trace labeled “data cycle” shows the temporal periods during which ion detection signals are acquired. The portions of the trace depicted via the solid lines indicate the data acquisition periods associated with one of the precursor ion species, namely, the one for which the solid lines are utilized in the EAD cycle trace. The portions of the trace depicted via the dashed lines indicate the data acquisition periods associated with the other precursor ion species, namely, the one for which the dashed lines are utilized in the EAD cycle trace, the right solid line indicates a part of the cycle for yet another precursor.

The timing diagram shows that the temporal period for data acquisition for each of the ion species extends beyond the time at which the last cycle of fragmentation, deceleration, and introduction of the ions into the ToF mass analyzer for that precursor ion species has been completed. In this manner, the detection and analysis of the fragment ions generated during a data acquisition period can continue while another precursor ion species is being introduced into an ion dissociation device to generate ion fragments thereof.

In some embodiments, the above approaches for improving the dynamic range and throughput of the system can be combined. In other words, the switching of the axial DC potential between the decelerating and accelerating DC potentials based on cycles of mass analysis (e.g., accelerating the ion packets during the last cycle as discussed above) can be combined with offsetting the data acquisition periods relative to respective cycles of fragmentation and introduction of the fragment ions into the collision cell, e.g., in a manner discussed above.

By way of illustration, FIG. 8B illustrates an example of a timing diagram for implementing this aspect of the present teachings in one embodiment.

With reference to FIGS. 9A, 9B, and 9C, a mass spectrometer 800 according to an embodiment of the present teachings can include an ion source (not shown) for generating ions that can be received by an ion guide Qjet via an orifice 802 of the mass spectrometer, where the Qjet ion guide includes a set of rods 801 arranged in a quadrupole configuration, two of which 801a/801b are visible in the figure and employs a combination of gas dynamics and radio frequency fields to cause focusing of the ions. The ions exiting the Qjet ion guide are received by an ion guide Q0 that includes a set of quadrupole rods 804, two of which 804a/804b are visible in the figure, to which RF voltages can be applied for causing radial confinement of the ions and generate an ion beam that is in turn received by an ion mass filter Q1. The ion guides Qjet, Q0, and the mass filter Q1 are disposed in differentially-pumped chambers that are maintained aprogressively lower pressures.

An ion lens IQ0 focuses the ions exiting the Q0 ion guide into the mass filter Q1.

The mass filter Q1 includes a stubby lens 806 that includes a set of quadrupole rods (two of which 806a/806b are visible in the figure) to which an RF field can be applied to cause focusing of the ions. The mass filter Q1 further includes a set of quadrupole rods 810, two of which 810a/810b are visible in the figure, to which a combination of RF and DC voltages can be applied to allow the selection of a precursor ion having a particular m/z ratio for transmission to a downstream electron reaction device 812 (herein also referred to electron reaction trap) in which the precursor ion can undergo electron capture dissociation, as discussed in more detail below. The selected precursor ion exiting from the set of quadrupole rods 810 is received by the downstream electron reaction device 812 through an ion lens IQ1. A stubby lens 816 positioned downstream of the quadrupole rod set 810 helps focus the selected precursor ion into the downstream electron reaction device 812.

The electron reaction device 812 includes two sets of L-shaped rods 812a/812b, that are positioned with an axial offset relative to one another to provide an ion trapping region 813 therebetween. The combination of the two sets of quadrupole rods provides an axial passageway 10 and a transverse passageway 12, where precursor ions can be introduced into the trapping region 813 via an inlet of the axial passageway and product ions generated via electron capture dissociation of the precursor ions or any other electron-induced fragmentation process, such as EIEIO (electron impact excitation of ions from organics), EID (electron induced dissociation), and any remaining precursor and/or charge reduced ions can exit the ion reaction device via an outlet of the axial passageway. An electron beam 815 can be introduced into the ion trapping region 813 via an inlet of the transverse passageway to interact with ions trapped in the ion trapping region 813, where the interaction of the electrons with the trapped ions can cause dissociation of the precursor ions, e.g., via electron capture dissociation. The electron beam can exit the ion reaction device via an outlet of the transverse passageway. Further details regarding the electron reaction device and its operation can be found, e.g., in U.S. Pat. No. 10,014,166, which is herein incorporated by reference in its entirety.

The fragment ions generated in the ion trapping region 813 are received by a collision cell Q2 via an ion lens IQ2. The collision cell Q2 is pressurized via introduction of nitrogen gas to allow collisional cooling of the ions received by the cell Q2. A pair of LINAC electrodes Q2L1 and Q2L2 are positioned in the collision cell and are axially separated from one another so that a DC potential difference can be maintained between them.

With particular reference to FIG. 9B, in this embodiment, a DC/RF voltage source 819 and a DC/RF voltage source 821 operating under control of a controller 823 can apply RF and DC voltages to the rods of the ECD cell and those of the collision cell to generate quadrupolar electric fields for providing radial confinement of the ions and to further provide a DC offset voltage between the rods of the Q2 cell and those of the upstream ECD cell. Another DC voltage source 825, which also operates under the control of the controller 823, supplies a DC voltage across the LINAC electrodes Q2L1 and Q2L2.

The combination of the DC offset voltages applied between the rods of the upstream ECD cell and those of the collision cell and the DC voltage applied across the LINAC electrodes results in the generation of an axial DC potential that can decelerate or accelerate the ions passing through the collision cell in order to “slow down” or “speed up” the ions. By way of example, the deceleration of the ions can be achieved by applying either neutral, reverse polarity or slightly positive LINAC voltages and matching potentials on other components, e.g., ECD, ST2, etc.

By way of illustration, FIG. 9C presents two traces each depicting the axial DC potential along the longitudinal axis of the mass spectrometer from the ST2 lens through the ECD cell and the downstream Q2 collision cell. The solid trace depicts an example of a longitudinal variation of the axial DC potential, which results in the ions being accelerated as they pass through the Q2 collision cell and the dashed trace depicts an example of a longitudinal variation of the axial DC potential, which results in the slow-down of the ions as they pass through the Q2 collision cell. More specifically, in the example depicted in FIG. 9C, the gradient of the axial DC potential depicted via the solid lines within the Q2 collision cell results in the generation of an electric field within the collision cell that accelerates the ions as they pass through the collision cell. In contrast, the gradient of the axial DC potential depicted via the dashed lines within the Q2 collision cell substantially vanishes.

Hence, in this case, the ions are slowed down via collisions with the background gas molecules present in the Q2 collision cell. As discussed above, in various embodiments, during an initial subset of a plurality of cycles of introduction of a precursor ion species into an ion fragmentation device, the fragmentation of the precursor ion species into a plurality of ion fragments and the introduction of those ion fragments into a downstream ToF mass analyzer, the ions are slowed down as they pass through the Q2 collision cell and the axial DC potential is adjusted in the last cycle (or in several consecutive terminal cycles) to speed up the ions as they pass through the Q2 collision cell.

In various embodiments, the deceleration and/or acceleration of the ions as they pass through a pressurized ion guide acting as an ion trap to generate a plurality of distinct ion packets can be adjusted so to obtain a desired ratio of the time difference between the arrival of two consecutive ion packets (temporal gap between two consecutive ion packets) at a downstream TOF mass analyzer relative to a width of the arrived ion packets (e.g., their full widths at half maximum (FWHM)). By way of example, the ratio of the temporal gap relative to the width of the ion packets can be, for example, in a range of about 0 ms to about 5 ms.

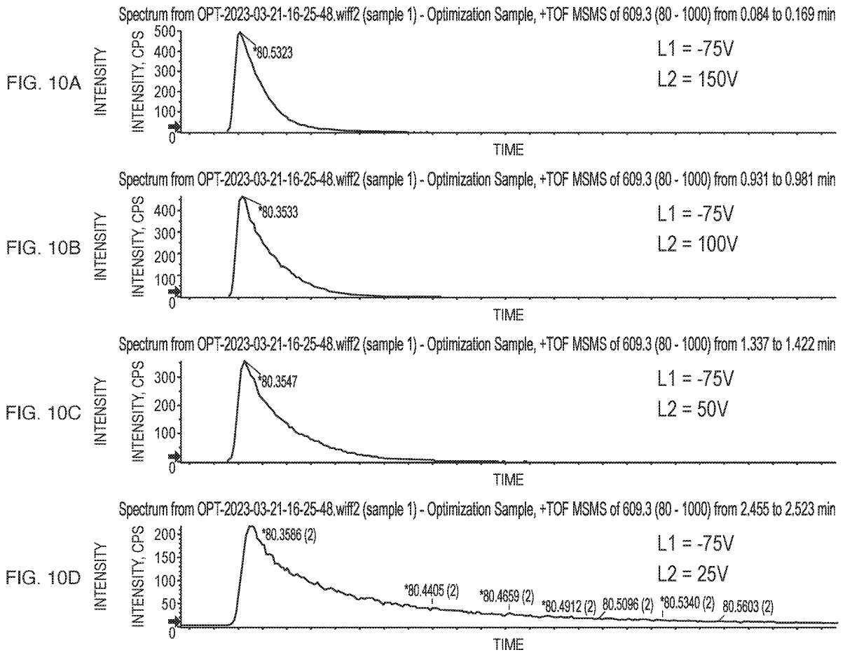

By way of illustration, FIGS. 10A, 10B, 10C, and 10D show measured arrival times distribution of a plurality of temporally distinct ion packets generated in an EAD cell of a TOF mass spectrometer, such as the mass spectrometer depicted in FIG. 9A, at the pusher electrode of the TOF mass analyzer. L1 and L2 refer, respectively, to the LINAC 1 and LINAC 2 electrodes. The data presented in these figures shows that at a slower axial gradient (i.e., smaller L2), a larger temporal spread of the ion packet is observed.

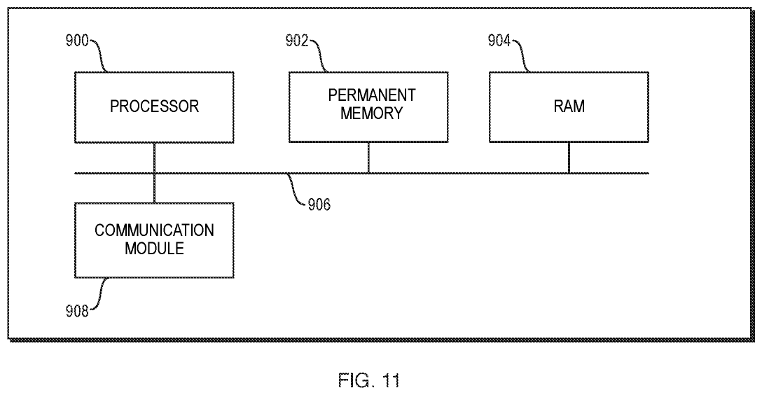

The controller 823 can be implemented in hardware, firmware and/or software and can be programmed to implement various methods according to the present teachings. By way of example, FIG. 11 schematically depicts an example of such an implementation where the controller includes a processor 900 that is in communication with a permanent memory module 902 and a random access memory (RAM) module 904 via a communication bus 906. The controller can also include a communications module 908 that allows the controller to communicate with the voltage sources and other devices. While in some embodiments, the controller can be integrated in the mass spectrometer in other embodiments it can be implemented as a stand-alone computer system that can provide operating instructions to the mass spectrometer.

The instructions for performing various methods according to the present teachings for performing mass spectrometry can be stored in the permanent memory module 902 and can be transferred to the RAM module 904 under the control of the processor 900 to be executed. By way of example, the instructions may provide DC offset voltages for application to the rods of the collision cell and/or other components (e.g., the rods of an upstream ion trap) for different cycles of mass analysis of a precursor ion species. Further, in some cases, the instructions can provide the timing of data acquisition periods relative to the timing of the fragmentation cycles of precursor ion species.

Referring again to FIG. 9A, the ions exiting the cell Q2 are focused by a set of ion focusing optics 815 into a time-of-flight (ToF) mass analyzer 818, which can provide mass analysis of those ions. More specifically, the ToF mass analyzer 818 includes an ion deflector (herein also referred to as an accelerator) 818a that can apply an accelerating voltage to a packet of ions to cause their travel through a field free region of the ToF analyzer toward an ion mirror 820, which can deflect the ions toward an opposed ion mirror 822, which in turn directs the ions to an ion detector 824, which can generate ion detection signals in response to the detection of the ions. The mass spectrometer 800 can include a dynamic range adjuster 826 for adjusting the dynamic range of the ion detector 824. The ion detection signals can be processed in a manner known in the art to generate a mass spectrum of the fragment ions.

Those having ordinary skill in the art will appreciate that various changes can be made to the above embodiments without departing from the scope of the present teachings.

What is claimed is:

1. A mass spectrometer, comprising:
an ion trapping device,
at least one pressurized ion guide configured to allow establishment of an adjustable axial field therein such that the axial field can be adjusted to operate the pressurized ion guide in any of a fast operational setting and a slow operational setting,
a mass analyzer for receiving ions passing through the pressurized ion guide and configured to provide mass analysis of the received ions, and
a controller in communication with said at least one pressurized ion guide for causing the adjustment of the axial field so as to switch the operational setting of the pressurized ion guide between the fast and the slow operational settings based on an operational mode of the mass spectrometer.

2. The mass spectrometer of claim 1, wherein the operational mode of the mass spectrometer is characterized by an inter-sample switching time associated with introduction of different precursor ions into the mass spectrometer during a single mass analysis run.

3. The mass spectrometer of claim 2, wherein the controller is configured to cause the ion guide to operate in the fast operational setting when said inter-sample switching time is less than about 2 ms.

4. The mass spectrometer of claim 2, wherein the controller is configured to cause the ion guide to operate in the slow operational setting when said inter-sample switching time is greater than about 5 ms.

5. The mass spectrometer of claim 1, wherein the ion trapping device is configured to operate as a flow-through ion guide.

6. The mass spectrometer of claim 4, wherein the controller is configured to cause adjustment of the axial field such that ions passing through the ion guide during the fast operational setting thereof remain substantially unfragmented.

7. The mass spectrometer of claim 1, wherein said controller is configured to cause adjustment of the axial field in the slow operational setting of the ion guide so as to prevent saturation of an ion detector of the mass analyzer.

8. The mass spectrometer of claim 1, wherein said controller is configured to cause adjustment of the axial field in the slow operational setting of the ion guide so as to prevent charge distortion effects in one or more mass spectra generated based on data acquired by the mass analyzer.

9. The mass spectrometer of claim 1, wherein said trapping device is configured to operate as an ion trap.

10. The mass spectrometer of claim 9, wherein said controller is configured to cause the axial ion guide to operate in the slow operational setting.

11. The mass spectrometer of claim 9, wherein said ion trap is configured to generate temporally distinct ion packets.

12. The mass spectrometer of claim 11, wherein the controller is configured to select the operational setting of the ion guide based on timing of generation of said temporally distinct ion packets.

13. The mass spectrometer of claim 12, wherein the controller is configured to select the slow operational setting of the ion guide for one or more of the ion packets generated during a first data acquisition interval and to select the fast operational setting of the ion guide for one or more of the ion packets generated during a second data acquisition interval, wherein the second data acquisition interval is subsequent to the first data acquisition interval.

14. The mass spectrometer of any one of claim 11, further comprising a DC voltage source operating under control of the controller for application of at least one DC voltage to the ion guide for generating said adjustable axial field.

15. The mass spectrometer of claim 14, wherein the controller causes the DC voltage source to apply a minimum DC voltage at which the axial field results in the ion packets arriving at the mass analyzer exhibiting a temporal spread below a target threshold.

16. The mass spectrometer of claim 15, wherein the controller is configured to determine said minimum DC voltage by successively increasing the at least one DC voltage applied to the ion guide and monitoring the temporal spread of the ions arriving at the mass analyzer.

17. The mass spectrometer of claim 1, wherein said ion guide comprises a plurality of rods arranged in a multipole configuration.

18. The mass spectrometer of claim 1, wherein said mass analyzer comprises a ToF mass analyzer.

19. The mass spectrometer of claim 1, wherein said ion trapping device comprises an ion-particle reaction device.

20. The mass spectrometer of claim 19, wherein said ion-particle reaction device comprises an electron activated dissociation (EAD) device.
